(19) United States
(12) Patent Application Publication
(10) Pub. No.: US 2025/0014768 A1
(43) Pub. Date: Jan. 9, 2025

(54) SUSPENDED URANIUM DIOXIDE FUEL

(71) Applicant: UT-Battelle, LLC, Oak Ridge, TN (US)

(72) Inventor: Ian Greenquist, Knoxville, TN (US)

(21) Appl. No.: 18/752,961

(22) Filed: Jun. 25, 2024

Related U.S. Application Data
(60) Provisional application No. 63/524,982, filed on Jul. 5, 2023.

(51) Int. Cl. G21C 3/52; G21C 3/64

(52) U.S. Cl. CPC G21C 3/52; G21C 3/64

(57) ABSTRACT

A nuclear reactor fuel is provided. The nuclear reactor fuel includes a liquid metal alloy, and uranium dioxide (UO₂) particles suspended in the liquid metal alloy. The UO₂ particles are enriched with uranium-235 (²³⁵U) in an amount of less than 20%. The nuclear reactor fuel has a thermal conductivity greater than a thermal conductivity of sintered UO₂ pellets at the same temperature. The liquid metal alloy may be a bismuth-lead-tin (Bi—Pb—Sn)-based alloy and a lead-tin (Pb—Sn)-based alloy. A concentration of the UO₂ particles in the liquid metal alloy may be up to 30 wt % or more. The UO₂ particles alternatively may be uranium carbide (UC) particles, uranium nitride (UN) particles, or tri-structural isotropic (TRISO) particles. A nuclear reactor is also provided. The nuclear reactor includes a reactor vessel and the nuclear reactor fuel. The nuclear reactor fuel is contained in or circulated through the reactor vessel.

### CROSS-REFERENCE TO RELATED APPLICATIONS

This application claims the benefit of U.S. Provisional Application No. 63/524,982, filed Jul. 5, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to nuclear reactor fuels, and more particularly to uranium dioxide-based fuels for nuclear reactors.

### BACKGROUND OF THE INVENTION

Conventional nuclear reactors cannot compete economically with natural gas and heavily subsidized wind power. Novel reactor designs are needed to improve the economics of nuclear energy. However, a major limiting factor in reactor design is the use of new structural materials. Only one new structural material has been approved for nuclear reactor use since the 1990s and required a 12-year-long campaign and significant monetary capital to accomplish. The difficulty and high cost of approving new materials for nuclear reactors has led to significant bottlenecks in the design and deployment of advanced reactors.

This limiting factor has led to two basic strategies for novel reactor development. Designers either update conventional light water reactor (LWR) designs to be marginally safer and cheaper, or they develop new reactor concepts by relying on previous reactor developments from the 1950s, 1960s, and 1970s. This second path has led to the odd situation of advanced reactor designs calling for materials, such as steels, that are no longer produced commercially.

Despite the reliance on these development strategies, there is a third potential path that has not been explored: development of novel reactor designs using conventional reactor materials. The primary goal of such a new reactor should be to simplify the reactor design as much as possible while improving safety. One way to improve safety is to improve the thermal conductivity of the fuel. Conventional sintered uranium dioxide (UO₂) fuel pellets used in conventional LWRs do not transport heat efficiently, so they require constant cooling even when the reactor is shut down. A fuel that transports heat more efficiently would be less likely to require constant cooling, and so may be better suited for accident scenarios. Thus, a need exists for improved nuclear reactor fuels.

### SUMMARY OF THE INVENTION

An improved nuclear reactor fuel is provided herein. In some embodiments, the nuclear reactor fuel includes a liquid metal alloy, and uranium dioxide (UO₂) particles suspended in the liquid metal alloy. The UO₂ particles are enriched with uranium-235 (²³⁵U) in an amount of less than 20% (an enrichment greater than 0% and less than 20%). The nuclear reactor fuel has a thermal conductivity greater than a thermal conductivity of sintered UO₂ pellets at the same temperature.

In specific embodiments, the liquid metal alloy is one of a bismuth-lead-tin (Bi—Pb—Sn)-based alloy and a lead-tin (Pb—Sn)-based alloy.

In particular embodiments, the liquid metal alloy is a Pb—Sn eutectic alloy.

In specific embodiments, the UO₂ particles are microparticles.

In specific embodiments, a concentration of the UO₂ particles in the liquid metal alloy is up to at least 30 wt. %.

In specific embodiments, an amount of uranium-235 (²³⁵U) enrichment of the UO₂ particles is in a range of between 3% and 20%.

In specific embodiments, the UO₂ particles are not sintered.

In specific embodiments, the UO₂ particles are not in pellet form.

In other embodiments, the nuclear reactor fuel includes a liquid metal alloy, and fuel particles suspended in the liquid metal alloy. The fuel particles are one of uranium dioxide (UO₂), uranium carbide (UC), uranium nitride (UN), and tri-structural isotropic (TRISO) particles.

In specific embodiments, the liquid metal alloy is one of a bismuth-lead-tin (Bi—Pb—Sn)-based alloy and a lead-tin (Pb—Sn)-based alloy.

In particular embodiments, the liquid metal alloy is a Pb—Sn eutectic alloy.

In specific embodiments, an amount of uranium-235 (²³⁵U) enrichment of the UO₂ particles is at least 3.0%.

In specific embodiments, the fuel particles have a mean particle diameter of less than approximately 1 mm.

In specific embodiments, the fuel particles are not sintered.

In specific embodiments, the fuel particles are not pellets.

A nuclear reactor is also provided. The nuclear reactor includes a reactor vessel and the nuclear reactor fuel in accordance with various embodiments disclosed herein. The nuclear reactor fuel is contained in or circulated through the reactor vessel.

In specific embodiments, the nuclear reactor is a light water reactor.

In particular embodiments, the nuclear reactor is one of a boiling water-type reactor and a pressurized water-type reactor.

In particular embodiments, the nuclear reactor is a pot-type light water reactor.

In specific embodiments, the nuclear reactor fuel is one of: i) circulated through the reactor vessel; ii) stirred within the reactor vessel; and iii) naturally circulated within the reactor vessel.

These and other features of the invention will be more fully understood and appreciated by reference to the description of the embodiments and the drawings.

### BRIEF DESCRIPTION OF THE DRAWINGS

FIG. 1 is a schematic view of a pot-type LWR including the nuclear reactor fuel in accordance with embodiments of the disclosure;

FIG. 2 is a schematic view of a heat pipe model geometry for simulating performance of a nuclear reactor using the nuclear reactor fuel;

FIG. 3 is a flow diagram of iteration loops of the simulation model;

FIG. 4 is a graph of critical outlet vapor quality for the simulation model as a function of uranium-235 enrichment and uranium dioxide concentration;

FIG. 5 is a graph of peak channel temperature for the simulation model as a function of uranium-235 enrichment and uranium dioxide concentration;

FIG. 6 is a graph of burnup for a fuel depletion simulation using low-enriched uranium (LEU) at 4.95% uranium enrichment;

FIG. 7 is a graph of peak pipe temperature for the fuel depletion simulation using the low-enriched uranium (LEU);

FIG. 8 is a graph of water inlet velocity for the depletion simulation using the low-enriched uranium (LEU);

FIG. 9 is a graph of vapor quality for the depletion simulation using the low-enriched uranium (LEU);

FIG. 10 is a graph of burnup for a fuel depletion simulation using high-assay, low-enriched uranium (HALEU) at 19.5% uranium-235 enrichment;

FIG. 11 is a graph of peak pipe temperature for the fuel depletion simulation using the high-assay, low-enriched uranium (HALEU) (19.5%);

FIG. 12 is a graph of water inlet velocity for the fuel depletion simulation using the high-assay, low-enriched uranium (HALEU) (19.5%);

FIG. 13 is a graph of vapor quality for the fuel depletion simulation using the high-assay, low-enriched uranium (HALEU) (19.5%);

FIG. 14 is a graph of burnup for a fuel depletion simulation using high-assay, low-enriched uranium (HALEU) at 10% uranium-235 enrichment;

FIG. 15 is a graph of peak pipe temperature for the fuel depletion simulation using the high-assay, low-enriched uranium (HALEU) (10%);

FIG. 16 is a graph of water inlet velocity for the fuel depletion simulation using the high-assay, low-enriched uranium (HALEU) (10%); and

FIG. 17 is a graph of vapor quality for the fuel depletion simulation using the high-assay, low-enriched uranium (HALEU) (10%).

### DETAILED DESCRIPTION OF THE CURRENT EMBODIMENTS

As discussed herein, the current embodiments relate to nuclear reactor fuels and nuclear reactors in which the nuclear reactor fuel is contained and consumed. Nuclear reactor fuels in accordance with the disclosure have improved thermal conductivity, which is thereby more efficient and in turn more easily cooled which can make a nuclear reactor operating with the nuclear reactor fuel safer. The nuclear reactor fuels also may exhibit high, uniform burnup, customizable energy density, and simplified performance. Nuclear reactor fuels and nuclear reactors in accordance with these embodiments are described in greater detail below.

The nuclear reactor fuel includes a liquid metal alloy that acts as a carrier for fuel material. The liquid metal alloy is preferably a bismuth-lead-tin (Bi—Pb—Sn)-based alloy or a lead-tin (Pb—Sn)-based alloy. The Bi—Pb—Sn-based or Pb—Sn-based alloy may further include minor amounts of one or more trace elements including but not limited to gallium (Ga), lithium (Li), and/or iron (Fe). The total composition of the trace elements is typically less than or equal to 1 percent by weight (wt. %). In some embodiments, the liquid metal alloy is a 1:1:1 Bi—Pb—Sn alloy (i.e., 33 wt. % Bi, 33 wt. % Pb, 33 wt. % Sn). In other embodiments, the liquid metal alloy is a Pb—Sn eutectic alloy (62 wt. % Sn). The Pb—Sn eutectic alloy is a common solder material and has a melting temperature of 183° C. (compared to a melting temperature of about 120° C. for Bi—Pb—Sn-based alloys), and a density of 7.7 g/cm³ at 300° C. (compared to a density of about 9.5 g/cm³ for Bi—Pb—Sn-based alloys). In yet other embodiments, the liquid metal alloy is a Pb—Sn-based alloy containing at least 20 wt. % Sn and having a melting temperature at or below about 292° C. Alternatively, the liquid metal alloy may be any other suitable alloy, so long as it has a melting temperature in this range and is compatible with nuclear reactor materials such as water, zircaloy, stainless steel, uranium, and the like. Further, the composition of the liquid metal alloy can be adjusted to vary and balance properties such as density, melting temperature, boiling temperature, and thermal conductivity.

Nuclear fuel particles are suspended in the liquid metal alloy. The nuclear fuel particles can move freely within the liquid metal alloy, thereby providing a uniform and high burnup distribution. In various embodiments, the nuclear fuel particles are uranium dioxide (UO₂) particles. The UO₂ particles are enriched with uranium-235 (²³⁵U) in an amount of less than approximately 20%, i.e. up to 20% of the uranium in the UO₂ particles is uranium-235. As such, the UO₂ particles are low-enriched uranium (LEU) particles having a uranium-235 content of less than 20%. In some embodiments, the UO₂ particles are enriched in an amount of at least 3.0%, optionally in the range of approximately 3.0% to 5.0%. In certain embodiments, the amount of uranium-235 enrichment is between approximately 4.0% and 5.0%. In yet other embodiments, the UO₂ particles are high-assay low-enriched uranium (HALEU) particles that are enriched with uranium-235 in an amount in the range of approximately 5% to 20%. Uranium-235 enrichment may be performed in any manner known in the art, including but not limited to gaseous diffusion methods and gas centrifuge methods.

The UO₂ particles are distinct from conventional sintered UO₂ pellets in that the particles are not subjected to a sintering process and/or the UO₂ particles are small particles and not in pellet form. Conventional uranium dioxide pellets are typically cylindrical in shape and may have a diameter nearly equal to its length, such as for example, a diameter and length both in a range of about 1 mm to 20 mm, e.g. approximately 12 mm×12 mm, or 0.5 inches×0.5 inches. As such, the present UO₂ particles typically have a mean diameter that is about 1 mm or less. In various embodiments, the UO₂ particles are microparticles having a mean diameter in the range of 1 μm (micron) to 1000 μm (i.e., 1 mm), optionally in the range of 1 μm to 750 μm, optionally in the range of 1 μm to 500 μm, optionally in the range of 1 μm to 250 μm, optionally in the range of 1 μm to 100 μm. In yet other embodiments, the UO₂ particles may have a mean diameter in the range of 0.1 μm to 1000 μm, optionally in the range of 0.1 μm to 750 μm, optionally in the range of 0.1 μm to 500 μm, optionally in the range of 0.1 μm to 250 μm, optionally in the range of 0.1 μm to 100 μm, optionally in the range of 0.1 μm to 50 μm, optionally in the range of 0.1 μm to 25 μm. The particle size can affect the amount of mixing required to achieve and maintain the suspension of the particles in the liquid metal alloy.

A concentration of the UO₂ particles in the liquid metal alloy is up to at least 30 wt. %, i.e., the concentration of UO₂ particles is up to 30 wt. % (less than or equal to 30 wt. %), optionally up to 32.5 wt. %, optionally up to 35 wt. %, optionally up to 37.5 wt. %, optionally up to 40 wt. %, and so on. In some embodiments, the concentration of UO₂ particles is in the range of greater than 0 wt. % to less than or equal to approximately 30 wt. %. In specific embodiments, the concentration of UO₂ particles is in the range of approximately 10 wt. % to 30 wt. %, optionally 10 wt. % to 20 wt. %, optionally 10 wt. % to 15 wt. %. In certain embodiments, the concentration of UO₂ particles is approximately 13 wt. %. Adjustment of the concentration of UO₂ particles in the suspension allows for the variation of the energy density to balance reactivity and safety. For example, as the concentration of UO₂ particles (and/or amount of uranium-235 enrichment) increases, the reactivity may increase as well as the peak coolant channel wall temperature, which is a limiting factor when the nuclear reactor fuel is utilized in a nuclear reactor.

In other embodiments, the UO₂ particles may be substituted with other nuclear fuel material particles such as particles of a uranium carbide (UC), a uranium nitride (UN), or a tri-structural isotropic (TRISO) fuel. Thus, the fuel particles may be one or more of UO₂ particles, UC particles, UN particles, or TRISO particles. TRISO particles are known in the art and are generally a fissile element-based (typically uranium) fuel material such as uranium dioxide, uranium oxycarbide, or uranium nitride encapsulated by multiple (typically three or sometimes more) layers of carbon-based and ceramic-based materials (e.g., graphite, pyrolytic carbon, SiC). As in the embodiments described above, the fuel particles (UO₂ particles, UC particles, UN particles, or TRISO particles) have a mean diameter that is about 1 mm or less, optionally a mean diameter in the range of 0.1 μm to 1000 μm (i.e., 1 mm), optionally in the range of 0.1 μm to 750 μm, optionally in the range of 0.1 μm to 500 μm optionally in the range of 0.1 μm to 250 μm, optionally in the range of 0.1 μm to 100 μm, optionally in the range of 0.1 μm to 5 μm, optionally in the range of 0.1 μm to 25 μm.

The thermal conductivity of the nuclear reactor fuel may be generally in the range of approximately 7 W/m·K to approximately 29 W/m·K at 400° C. and is dependent upon the concentration of the UO₂ particles (or other fuel particles) in the suspension. UO₂ particles have a lower thermal conductivity than the liquid metal alloy, and as such, the greater the concentration of UO₂ particles in the suspension, the lower the thermal conductivity. Thus, lowering the concentration of UO₂ particles improves the overall thermal conductivity of the nuclear reactor fuel suspension. At the same time, to provide the same fuel density at a lower concentration of UO₂ particles (and hence higher thermal conductivity), the amount of enrichment of the UO₂ particles may be increased. Thermal conductivity is also dependent upon temperature, and the range of thermal conductivity of the nuclear reactor fuel increases with temperature. For example, at 500° C. the thermal conductivity of the nuclear reactor fuel is generally in the range of approximately 5 W/m·K to approximately 34 W/m·K, while at 220° C. the thermal conductivity of the nuclear reactor fuel is generally in the range of approximately 9 W/m·K to approximately 22 W/m·K.

The nuclear reactor fuel according to the embodiments described above can be used as the fuel for a nuclear reactor including a reactor vessel in which the fuel is either contained in or circulated through the reactor vessel. In many embodiments, the nuclear reactor is defined as a light water reactor (LWR) in the general sense that the nuclear reactor uses light water (rather than heavy water, i.e., deuterium oxide) as the coolant and moderator. Conventional LWRs all use sintered low-enriched UO₂ fuel pellets arranged in fuel rods and clad in zirconium-based alloys as well as neutron poison control rods or blades to control the power level. In contrast, the present nuclear reactor is a LWR that uses a different fuel, namely the nuclear reactor fuel described above which comprises fissile particles suspended in liquid metal alloy. Further, conventional LWRs are divided into two types: pressurized water reactors (PWRs) and boiling water reactors (BWRs). The primary conceptual difference between the two is that BWRs operate at a lower pressure, allowing a portion of the water to boil, wherein the water vapor is sent to a steam turbine and the remaining liquid is pumped back into the core. On the other hand, PWRs do not boil the primary water coolant, and instead the coolant is sent to a heat exchanger called a steam generator to boil water in a secondary loop. The present nuclear reactor may be a boiling water-type reactor or a pressurized water-type reactor having the same conceptual function as conventional PWRs or BWRs (low pressure boiling of water to drive a steam turbine vs. sending pressurized, heated coolant to heat exchanger to boil water in a secondary loop) but not all of the other elements of conventional reactors such as fuel pellets, fuel rods, control rods, etc. Thus, the present boiling water-type reactor or a pressurized water-type reactor is similar in function to conventional BWRs or PWRs but do not refer to BWRs and PWRs in the conventional sense of their construction.

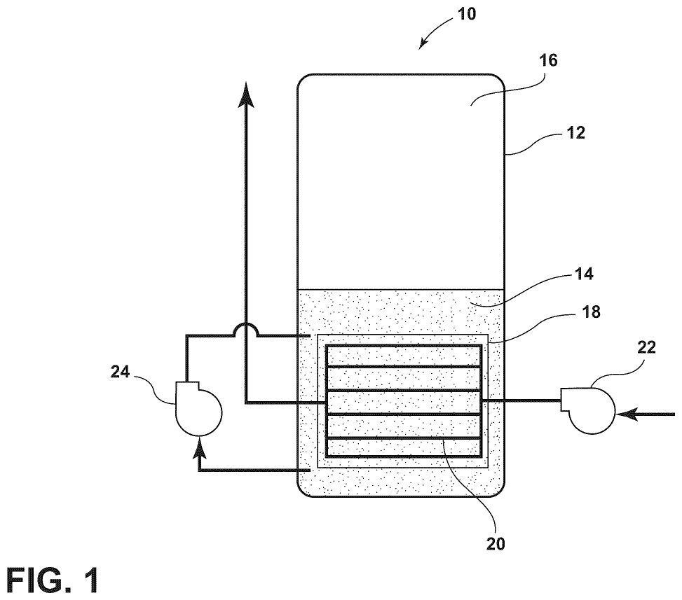

With reference to FIG. 1, in certain embodiments the present nuclear reactor may be an integral pot-type reactor 10. The pot-type reactor 10 includes a reactor pressure vessel (RPV) 12 containing a fuel pool (pot) 14 and a gas filled region that forms a plenum 16. The fuel pool 14 is formed of the nuclear reactor fuel described herein. A core 18 is disposed within the fuel pool 14 and is a region of the fuel pool that includes water coolant channels 20. Water is pumped through the core 18 by one or more pumps 22 and is heated within the core by the nuclear reactor fuel. The reaction rater is controlled by the water flow rate entering the core 18 and is governed by the pump(s) 22. One or more electromagnetic (EM) pumps 24 may circulate the nuclear reactor fuel through the fuel pot 14 in the reactor vessel 12 to maintain the suspension. While the EM pump(s) 24 is shown outside the reactor vessel 12, the EM pump(s) may be disposed within the reactor vessel. As such, the nuclear reactor fuel may be stirred within the reactor vessel rather than circulated through the reactor vessel. In yet other embodiments, the reactor may not include EM pumps and instead the nuclear reactor fuel may circulate naturally within the fuel pool. Enhanced heat transport provided by the nuclear reactor fuel may allow decay heat to be passively removed from the core 18 to the remaining fuel pool 14, reflectors (if present; not shown), and reactor pressure vessel 12 walls. Excess reactivity may be mitigated via burnable poisons mixed with the nuclear reactor fuel; in this arrangement, control rods need not be used because control would be maintained entirely by the water flow rate. Fission gas may be collected in the plenum region 16 or by a fission gas removal system (not shown). Shielding as well as a steam separation and feedback system are not shown in the schematic view shown in the drawing but may be included in the reactor system. The pot-type reactor 10 may advantageously provide for a reduced burnup rate since the excess fuel in the fuel pool/pot would continuously mix with the fuel in the core, thereby reducing the rate of fuel utilization. Further, as noted above, the excess fuel in the fuel pool/pot may suitably function as a heat sink for decay heat.

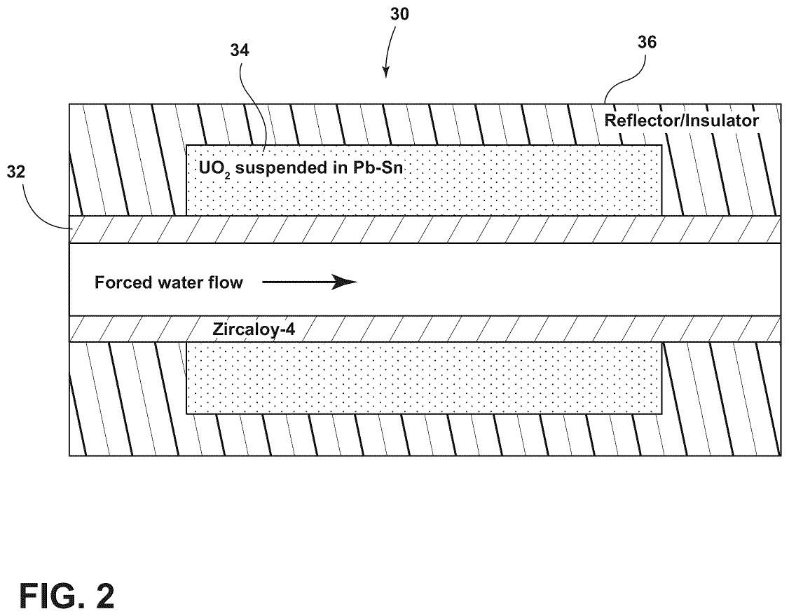

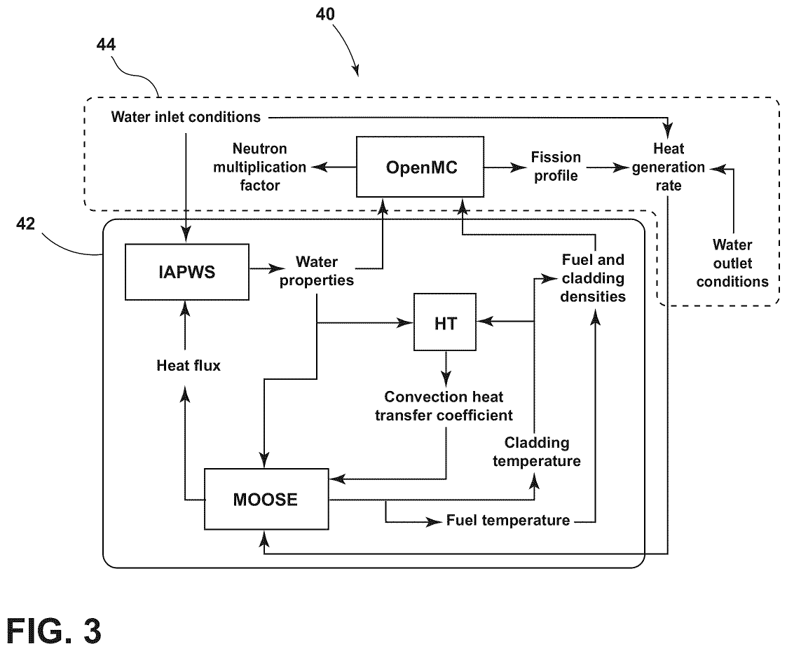

With reference now to FIGS. 2 and 3, a heat pipe simulation was conducted to model the thermal conductivity of the nuclear fuel, the effect of UO₂ concentration on the thermal conductivity, the level of uranium enrichment required, the fuel reactivity, and the peak achievable fuel utilization. With reference to FIG. 2, the simple heat pipe core geometry 30 consisted of a cylindrical channel wall 32 composed of Zircaloy-4. Water was modeled to flow vertically inside the channel, and some of the water was allowed to boil. Stagnant fuel 34 with a constant UO₂ concentration was disposed outside the channel. The fuel was surrounded by a perfect reflector and insulator 36, so no neutron nor heat leakage occurred. The core was modeled at steady-state operating conditions. Four open-source software modules were used to build the model. The models were OpenMC (a Monte Carlo-based neutron transport code used to calculate volumetric fission rate profiles and the neutron multiplication factor), MOOSE (a finite element partial differential equation solver used to model the heat conduction equation in the fuel and coolant channel wall), IAPWS (a module used to calculate the physical and thermodynamic properties of water and steam), and HT (a Python package used to calculate heat convection coefficients for the channel wall-water boundary condition). The model was constructed in Python, and a flowchart of the model illustrating the information passed between the four modules is shown in FIG. 3. The module 40 included an inner iteration loop 42 and an outer iteration loop 44. The channel wall thickness was held constant at 0.9 mm, which is the thickness of a standard BWR cladding wall. The channel's inner radius and the fuel's outer radius were 25 mm and 35.9 mm, respectively, and were optimized to maximize the neutron multiplication factor. The core length was held constant at 2.5 m. The inlet and outlet channel lengths were set to 0.25 m each to minimize leakage. The water inlet temperature and pressure were set to standard BWR conditions of 216° C. and 7.17 MPa, respectively. The model was assumed to be isobaric, so the pressure was set as constant throughout. The water inlet velocity was held constant at 3.5 m/s. The energy per fission was assumed to be 200 MeV.

The modeling included 840 simulations using twelve UO₂ weight fractions between 3% and 25%, seven enrichment levels between 1.5% and 4.5%, and ten outlet vapor qualities between 5% and 50%. The overall fission rate of each simulation was set to produce the specified outlet vapor quality. For each enrichment and UO₂ weight fraction, increasing the vapor quality (which can be accomplished by increasing fission rate and/or decreasing water flow rate) decreased the neutron multiplication factors (k_{eff}) until the reaction became subcritical. This suggests that the reaction is self-regulating and can be controlled by the water flow rate. More particularly, the self-regulating control mechanism can be described as follows. Increasing the UO₂ concentration increases the local fission rate, which increases the rate of heat flux to the water. The rate of heat flux to the water reduces the boiling onset height, which removes moderation and slows the fission reaction above the onset height. However, as the UO₂ concentration increases, the total energy produced also increases. Therefore, ever-increasing fission is limited to an ever-decreasing region of the core, and the heat generation profile exhibits a higher and sharper peak.

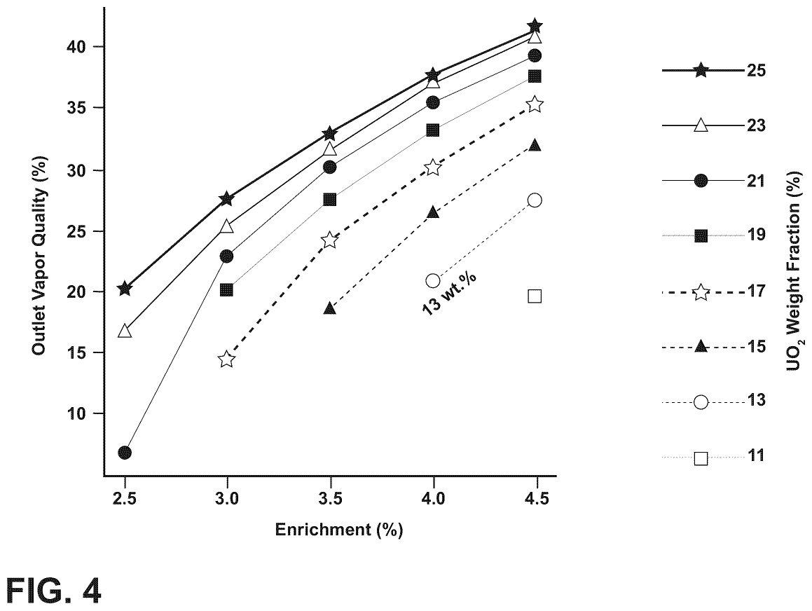

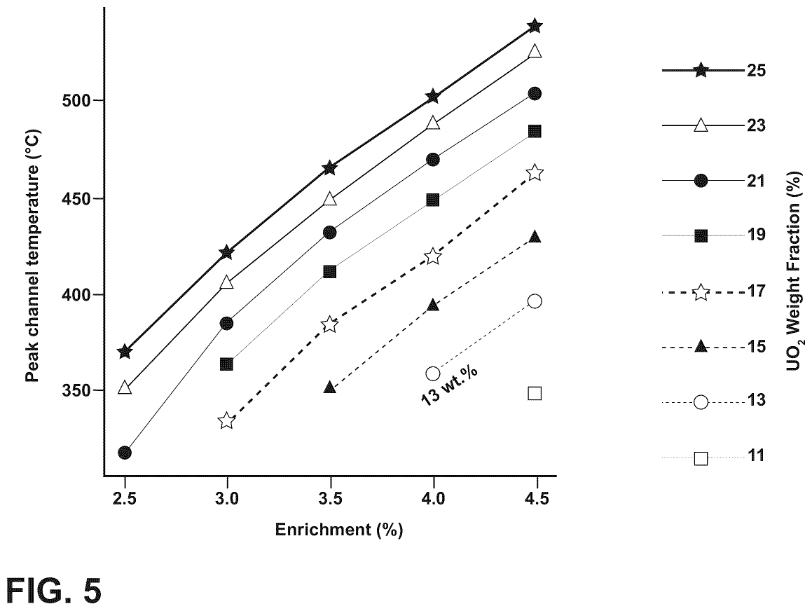

For steady-state operating conditions, the multiplication factor must equal 1.00. To check the conditions, the multiplication factors at various vapor qualities were linearly interpolated to find the vapor quality at which the reaction was critical. The critical vapor quality and peak channel temperature are shown in FIGS. 4 and 5 as functions of uranium-235 enrichment and UO₂ weight fraction. Both vapor quality and peak channel temperature increased with increasing uranium-235 enrichment and UO₂ weight fraction. As the enrichment increased, the vapor quality and cladding temperature also increased. Since the model used enrichment as a surrogate for burnup, this suggests a tradeoff exists between the potential fuel utilization and the peak channel operating temperature.

As UO₂ concentration and/or uranium-235 enrichment increased, the peak coolant channel wall temperature also increased. Thus, UO₂ concentration is limited by the peak channel wall temperature, which in some cases is around 300° C. but in other cases may be up to 1200° C. The coolant wall temperature may also be limited by corrosion from the fuel. For purposes of the simulation, the peak pipe temperature was limited to 400° C.

The peak achievable burnup is likely limited by the available excess reactivity. At 13 wt. % UO₂, the heat pipe could maintain criticality at 4.0% uranium-235 enrichment. This is equivalent to a burnup of 4.9 GWd·MTU⁻¹. The actual burnup may be increased by fuel breeding or the introduction of poison control elements.

Similarly modeled simulations were also performed to measure the burnup at three different levels of uranium-235 enrichment over an extended period of time. The main design differences between these simulations and the simulation discussed above were the calculation of fuel depletion over time, the inclusion of a burnable poison in the fuel (Gd₂O₃), and the setting of the power output to a specified value father than the water flow rate.

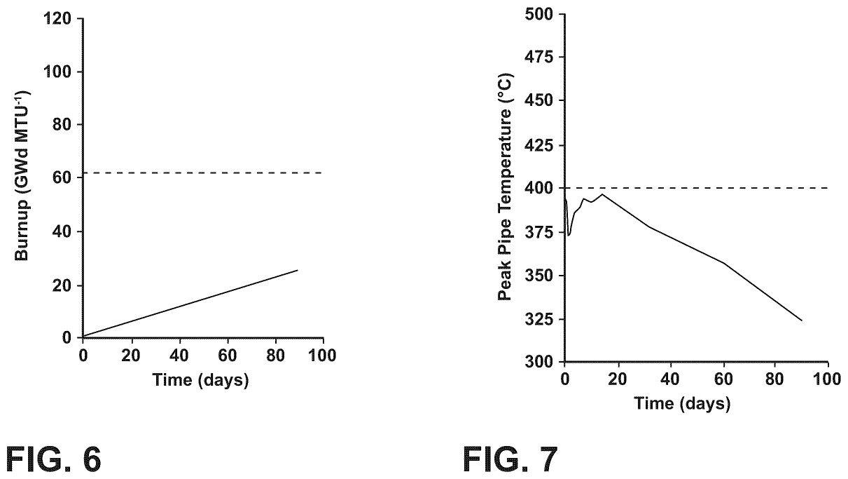

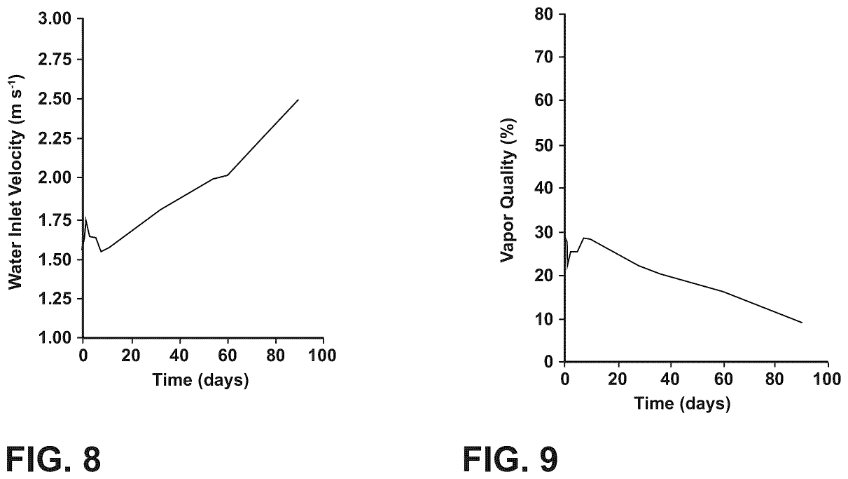

First, low-enriched uranium (LEU) at a uranium-235 enrichment of 4.95% was considered over a 90-day period of time. An optimum operating regime was determined that would keep the peak pipe temperature below 400° C. while maximizing the amount of uranium in the core. To identify the ideal operating regime, simulations were performed with fresh fuel throughout the potential operating domain. A set of conditions that led to acceptable temperatures and good control was 2 MW power with a fuel composed of 20 wt. % UO₂ and 0.02 wt. % Gd₂O₃. These conditions were used in a depletion simulation that lasted 90 days. As shown in FIGS. 6-9, the heat generation rate was held constant by adjusting the water inlet velocity. Early in the core lifetime, the water inlet velocity had to be decreased, but after ˜10 days, the velocity increased relatively uniformly. Throughout this time, the peak pipe temperature stayed below 400° C. The peak pipe temperature and vapor quality profiles were both mirror images of the water inlet velocity. The burnup accumulated at a rate of 277.4 MW·MTU⁻¹, resulting in a peak burnup of 25.0 GWd·MTU⁻¹.

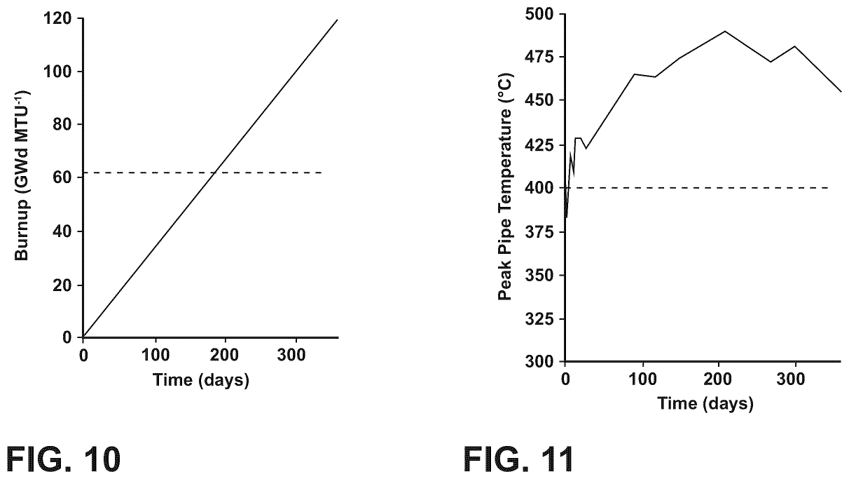

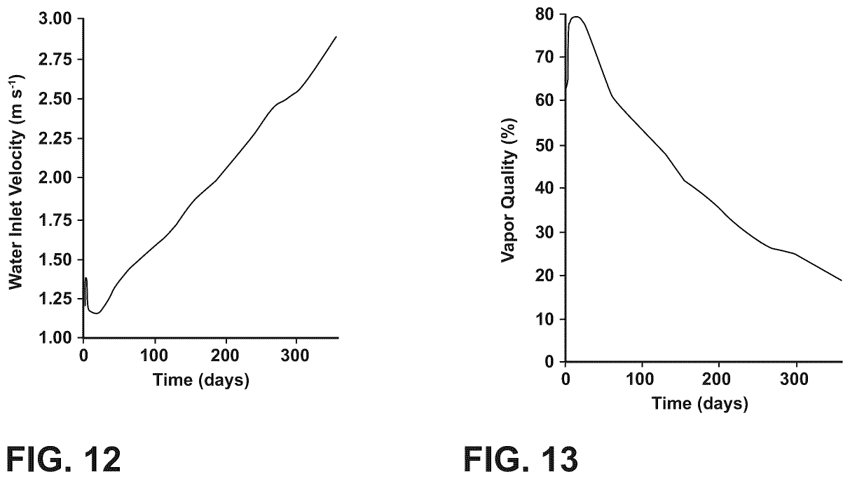

Second, high-assay LEU (HALEU) at a uranium-235 enrichment of 19.5% was considered. As shown in FIGS. 10-13, for HALEU the burnup increased at a rate of 328 MW·MTU⁻¹ for the entire 360-day simulation, resulting in a peak burnup of 118.2 GWd·MTU⁻¹. The peak pipe temperature started at 399.7° C. and then increased substantially to a peak of 489.3° C. at 210 days. The water inlet velocity initially dropped but then began increasing relatively linearly from 1.2 m/s to 2.9 m/s. Changing the velocity caused the vapor quality to change in an inverse correlation. It peaked at 79% and went down to 18% after 360 days.

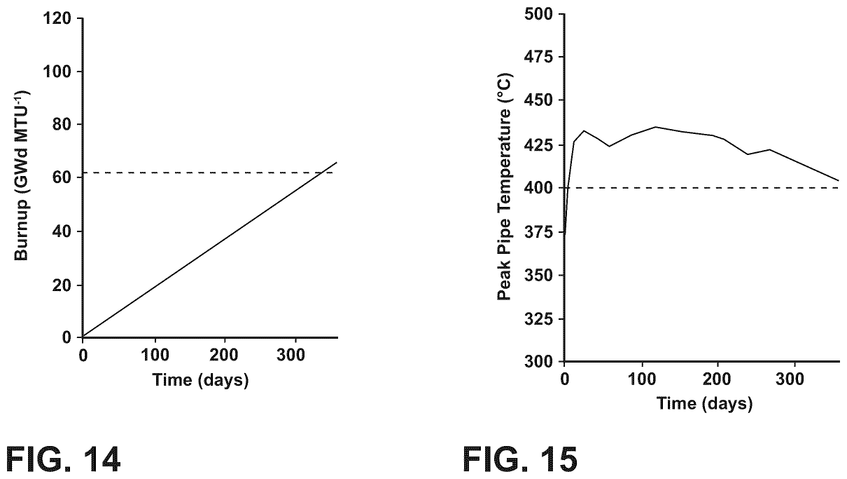

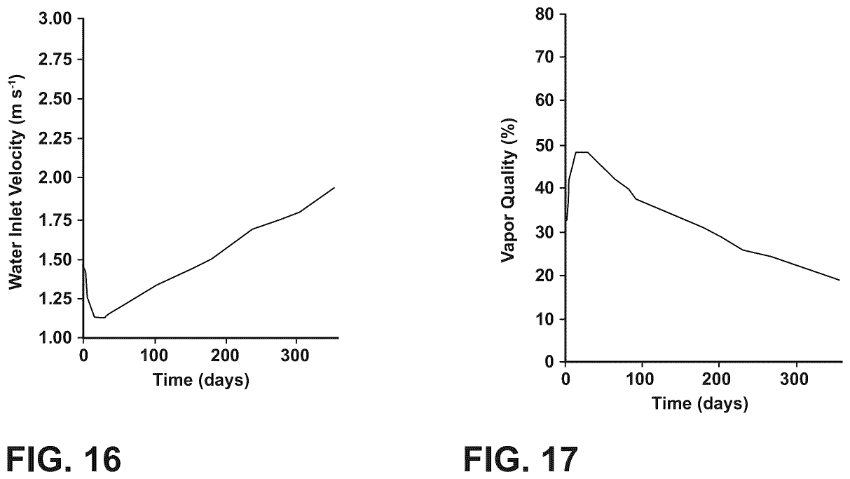

Third, an intermediate LEU enrichment level of 10% was considered. As shown in FIGS. 14-17, for 10% enrichment the burnup rate was 180 MW·MTU⁻¹, resulting in a peak burnup of 64.7 GWd·MTU⁻¹. The peak pipe temperature started within the 400° C. limit (379.0° C.), but quickly exceeded the limit and achieved a peak temperature of 434° C. at 120 days. The water inlet velocity started at 1.39 m/s, decreased to 1.12 m/s from days 14 to 30, then increased to 1.93 m/s. The water vapor quality started at 34.2%, increased to a peak of 47.9%, and then decreased to 18.2%. The changes in vapor quality were directly proportional to the water inlet velocity.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A nuclear reactor fuel comprising:
a liquid metal alloy; and
uranium dioxide (UO₂) particles suspended in the liquid metal alloy, wherein the UO₂ particles are enriched with uranium-235 (²³⁵U) in an amount of less than 20%;
wherein the nuclear reactor fuel has a thermal conductivity greater than a thermal conductivity of sintered UO₂ pellets at the same temperature.

2. The nuclear reactor fuel of claim 1, wherein the liquid metal alloy is one of a bismuth-lead-tin (Bi—Pb—Sn)-based alloy and a lead-tin (Pb—Sn)-based alloy.

3. The nuclear reactor fuel of claim 2, wherein the liquid metal alloy is a Pb—Sn eutectic alloy.

4. The nuclear reactor fuel of claim 1, wherein the UO₂ particles are microparticles.

5. The nuclear reactor fuel of claim 1, wherein a concentration of the UO₂ particles in the liquid metal alloy is up to at least 30 wt. %.

6. The nuclear reactor fuel of claim 1, wherein an amount of uranium-235 (²³⁵U) enrichment of the UO₂ particles is in a range of between 3% and 20%.

7. The nuclear reactor fuel of claim 1, wherein the UO₂ particles are not sintered.

8. The nuclear reactor fuel of claim 1, wherein the UO₂ particles are not in pellet form.

9. A nuclear reactor fuel comprising:
a liquid metal alloy; and
fuel particles suspended in the liquid metal alloy;
wherein the fuel particles are one of uranium dioxide (UO₂), uranium carbide (UC), uranium nitride (UN), and tri-structural isotropic (TRISO) particles.

10. The nuclear reactor fuel of claim 9, wherein the liquid metal alloy is one of a bismuth-lead-tin (Bi—Pb—Sn)-based alloy and a lead-tin (Pb—Sn)-based alloy.

11. The nuclear reactor fuel of claim 10, wherein the liquid metal alloy is a Pb—Sn eutectic alloy.

12. The nuclear reactor fuel of claim 9, wherein an amount of uranium-235 (²³⁵U) enrichment of uranium in the fuel microparticles is at least 3.0%.

13. The nuclear reactor fuel of claim 9, wherein the fuel particles have a mean particle diameter of less than approximately 1 mm.

14. The nuclear reactor fuel of claim 9, wherein the fuel particles are not sintered.

15. The nuclear reactor fuel of claim 9, wherein the fuel particles are not pellets.

16. A nuclear reactor comprising:
a reactor vessel; and
the nuclear reactor fuel of claim 1, wherein the nuclear reactor fuel is contained in or circulated through the reactor vessel.

17. The nuclear reactor of claim 16, wherein the nuclear reactor is a light water reactor.

18. The nuclear reactor of claim 17, wherein the nuclear reactor is one of a boiling water-type reactor and a pressurized water-type reactor.

19. The nuclear reactor of claim 17, wherein the nuclear reactor is a pot-type light water reactor.

20. The nuclear reactor of claim 16, wherein the nuclear reactor fuel is one of: i) circulated through the reactor vessel; ii) stirred within the reactor vessel; and iii) naturally circulated within the reactor vessel.
